(19) United States
(12) Patent Application Publication
(10) Pub. No.: US 2010/0057452 A1
(43) Pub. Date: Mar. 4, 2010

(54) SPEECH INTERFACES

(75) Inventors: Kunal Mukerjee, Redmond, WA (US); Brendan Meeder, Wexford, PA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/200,250

(22) Filed: Aug. 28, 2008

(51) Int. Cl. G10L 15/00; G10L 15/16

(52) U.S. Cl. 704/232; 704/231; 704/270; 704/E15.017; 704/E15.014

(57) ABSTRACT

The described implementations relate to speech interfaces and in some instances to speech pattern recognition techniques that enable speech interfaces. One system includes a feature pipeline configured to produce speech feature vectors from input speech. This system also includes a classifier pipeline configured to classify individual speech feature vectors utilizing multi-level classification.

### BACKGROUND

Consumers are embracing ever more mobile lifestyles. These consumers are also adopting portable digital devices that facilitate mobile lifestyles. For instance, consumers tend to carry Bluetooth wireless headsets, cell phones, cell/smart phones and/or personal digital assistants (PDAs) most of their waking hours. Inherently, for convenience reasons, these portable digital devices tend to be small and as such traditional computing interfaces such as keyboards tend to be either so small, such as on a smart phone, as to be cumbersome at best, or non-existent on other devices like Bluetooth headsets. Accordingly, a speech interface would be convenient. One manifestation of a speech interface can employ speech recognition technologies. However, existing speech recognition technologies, such as those employed on personal computers (PCs) are too resource intensive for many of these portable digital devices. Further, these existing technologies do not lend themselves to adaptation to low resource scenarios. In contrast, the present concepts lend themselves to low resource speech interface scenarios and can also be applied in more traditional resource-rich/robust scenarios.

### SUMMARY

The described implementations relate to speech interfaces and in some instances to speech pattern recognition techniques that enable speech interfaces. One system includes a feature pipeline configured to produce speech feature vectors from speech. This system also includes a classifier pipeline configured to classify individual speech feature vectors utilizing multi-level classification.

Another implementation is manifested as a technique that offers speech pattern matching. The technique receives user speech. The technique identifies a probability that a duration of the speech matches one or more phoneme classes, where phoneme classes include one or more phonemes. The technique further determines a probability that the duration matches an individual phoneme of an identified phoneme class.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 illustrates an exemplary speech pattern recognition system in accordance with some implementations of the present concepts.

FIGS. 2-11 illustrate individual features of the speech pattern recognition system of FIG. 1 in greater detail in accordance with some implementations of the present concepts.

FIGS. 12-13 illustrate exemplary environments in which speech interfaces and speech pattern recognition can be employed in accordance with some implementations of the present concepts.

### DETAILED DESCRIPTION

### Overview

This patent application pertains to speech interfaces. A speech interface can be thought of as a technology that allows a user to interact with a digital device. Speech interfaces can enable various functionalities. For instance, a speech interface may allow a user to issue commands to a portable digital device. In another case a speech interface may offer a searchable Dictaphone functionality on a portable digital device.

The speech interfaces can involve what can be termed as “speech pattern recognition” techniques. The speech pattern recognition techniques can be supported by speech processing architecture and classifier algorithms that start processing raw speech signals to produce phoneme-based speech descriptor symbols (hereinafter, “symbols” or “descriptors”). The symbols can be indexed and recalled to achieve the searchable Dictaphone functionality. The speech interfaces can also support speech-based indexing and recall to access other types of services and perform speech to text transcription. Stated another way, the present techniques can produce a 1-way hash function from raw speech of any given single user to a lattice of symbols. The symbols can be indexed for subsequent recall.

### Exemplary Implementations

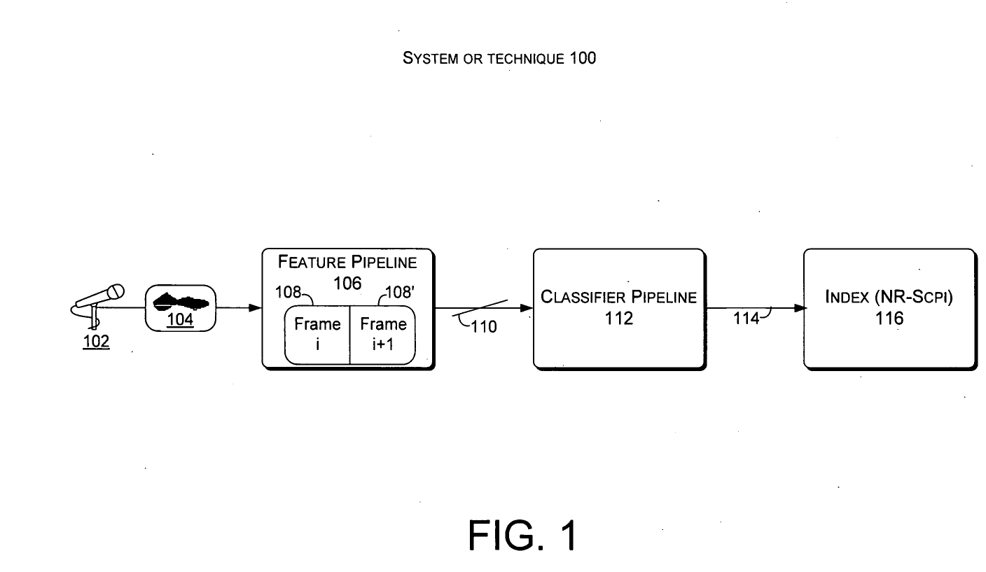

FIG. 1 shows a high-level illustration of one implementation of a speech pattern recognition system or technique 100. The speech pattern recognition system includes a source 102 of audio, such as a microphone that can be accessed by a user. Source 102 feeds digital speech or audio samples 104 for receipt by a feature pipeline 106. The feature pipeline 106 can perform a sequence of digital signal processing (DSP) operations on individual frames 108, 108′ of the incoming audio samples 104. So, the input speech can be analyzed as a series of frames having a selected duration. The feature pipeline can output a speech feature vector, X(t), 110 for individual frame(s) 108. Speech feature vector(S) 110 can then be processed by a classifier pipeline 112. The classifier pipeline can output a sequence of sound symbols 114 corresponding to an individual speech feature vector 110. This sequence of symbols 114 can be indexed at 116, and can be subsequently retrieved.

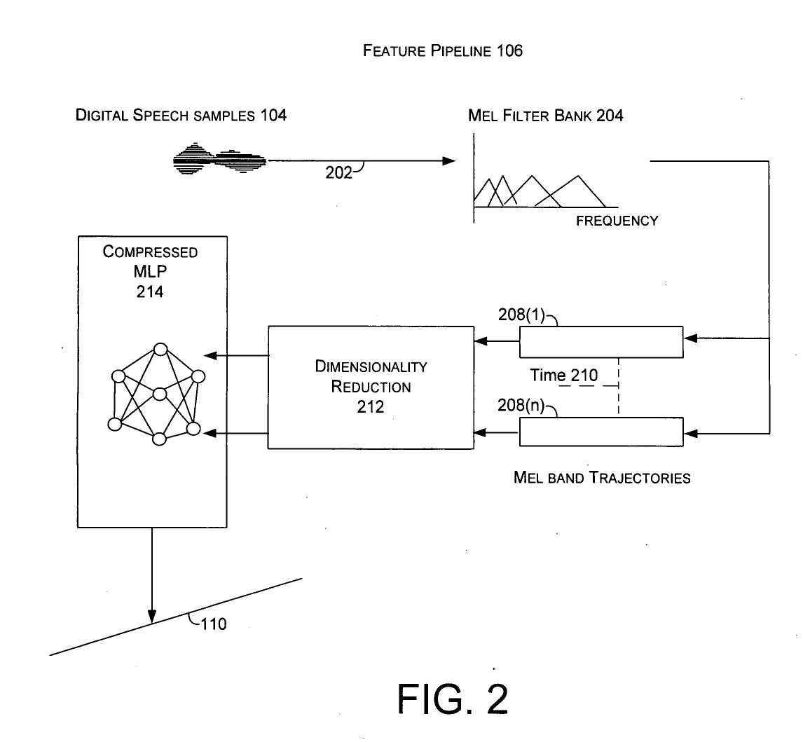

The concepts introduced in relation to system 100 lend themselves to resource constrained implementations. Specific manifestations of these concepts are described in more detail below in relation to FIGS. 2-11.

### Exemplary Feature Pipeline

FIGS. 2-4 collectively show a more detailed illustration of one implementation of feature pipeline 106 introduced in relation to FIG. 1. Briefly, feature pipeline 106 receives digital speech samples 104 as input at 202. The digital speech samples 104 can be processed by a Mel filter bank 204 to produce one or more Mel bands or trajectories 208(1)-208(n) per frame or duration of time 210. The Mel bands are subject to dimensional reduction at 212 and are subject to compression by a multi-layered perceptron (MLP) at 214. The MLP can be configured such that the number of output nodes of the MLP equals the number of phoneme classes (discussed below) utilized in the implementation. The result of these processes is speech feature vector, X(t), 110. Briefly, the feature pipeline 106 can operate on individual frames of input speech to produce an output stream of speech feature vectors. In one example described below these speech features are based on Mel Cepstral Coefficients.

In one case, the Mel-filter bank 204 transforms the digital speech samples 104 into Mel-filter bank coefficients along n bands (e.g. n is selected from a range of 5-40). In some cases, the number of bands selected is between 15 and 23. Next, the technique lines up the coefficients from each individual Mel-band in time order at 210, so as to get an idea of how each band is evolving over time. This can be accomplished with a two dimensional (2-D) Cepstral (TDC) representation. This process generates the “Mel band trajectories” 208(1)-208(n).

Some implementations then apply a Discrete Cosine Transform DCT to each Mel band trajectory 208(1)-208(n), to compact feature information into a reduced number of coefficients. These compacted or dimensionality-reduced Mel coefficients are used as inputs to the classifier pipeline and this process can serve to reduce the complexity of the classifier pipeline. Further, the compacted or dimensionality-reduced Mel coefficients facilitate resource constrained applications in that downstream processing and storage requirements are substantially decreased due at least to the decrease in the volume of data output by feature pipeline 106.

The following description includes greater levels of detail relating to one implementation of feature pipeline 106. In this case, a processing unit is considered as one frame of digital speech sample 104. A frame is a window of 256 (mono) pulse code modulation (PCM) samples, which corresponds to 32 milliseconds. The technique slides the “frame window” forward each time by 80 samples, or 10 milliseconds (ms), i.e. the technique effectively retires 80 samples out from the left and reads in 80 new samples from the right of the time line. Accordingly, 176 samples overlap from the past and present frames. The sample size and durations recited here are for purposes of example and other implementations can utilize other sample sizes and/or durations.

The technique first accomplishes what can be termed “power level normalization”. First, the technique computes the sum of squared PCM samples over a frame of audio (256 samples). Then the technique computes the normalization factor as the square root of the normalized target energy per frame (a pre-set/constant value) divided by the sum of squared energy. Finally, the technique multiplies each sample by the normalization factor. This becomes the frame of normalized samples. In summary, the technique can perform normalization of speech samples with regard to some reference level. This allows the technique to more accurately compare input data from different recording environments, capture devices, and/or settings and allows more accurate comparison of input data to any training data utilized by a given system.

Next, the technique applies a Hamming window to each frame's worth of audio data (i.e., digital speech sample). For each frame, the Hamming window operation applies a smooth window over the 256 samples in that frame, using, for example, the following operation:

```
for (i = 0; i < FrameLength; ++i)
  Frame[i] = Frame [i] * (0.54 − 0.46
        * Cos(2.0f * (float)PI * i / (FrameLength − 1))
```

Next, the technique applies Discrete Fourier Transform (DFT) to the frame of audio. This is a standard radix-4 DFT algorithm. DFT is given by the following equation for each input frame, where x(n) is the input signal, X(k) is the DFT, and N is the frame size:

$$X ( k ) = {\sum }_{n = 0}^{N - 1} x ( n ) {e}^{- j2π \frac{km}{N}} \qquad 0 \leq k \leq N - 1$$

Further, the technique computes the Power spectrum out of the real and imaginary components of the DFT computed above. This can be thought of as the squared magnitude of the DFT, as given by the following equation:

|X(k)|²=X(k)X(k)⁴

The spectrum is then warped on a Mel-frequency scale, according to the following triangular M-band filter bank with m ranging from 0 to M−1. Here, Hₘ(k) is the weight given to the k^{th} energy spectrum bin contributing to the m^{th} output band.

$${H ( k )}_{m} = \{ \begin{matrix}0 & k < f ( m - 1 ) or k > f ( m + 1 ) \\ \frac{2 ( k - f ( m - 1 ) )}{f ( m ) - f ( m - 1 )} & f ( m - 1 ) < k < f ( m ) \\ \frac{2 ( f ( m + 1 ) - k )}{f ( m + 1 ) - f ( m )} & f ( m ) \leq k \leq f ( m + 1 )\end{matrix}$$

The linear-to-Mel frequency transformation is given by the formula given below, where frequency (f) is in hertz (Hz):

$$Mel ( f ) = 1127 ln ( 1 + \frac{f}{700} )$$

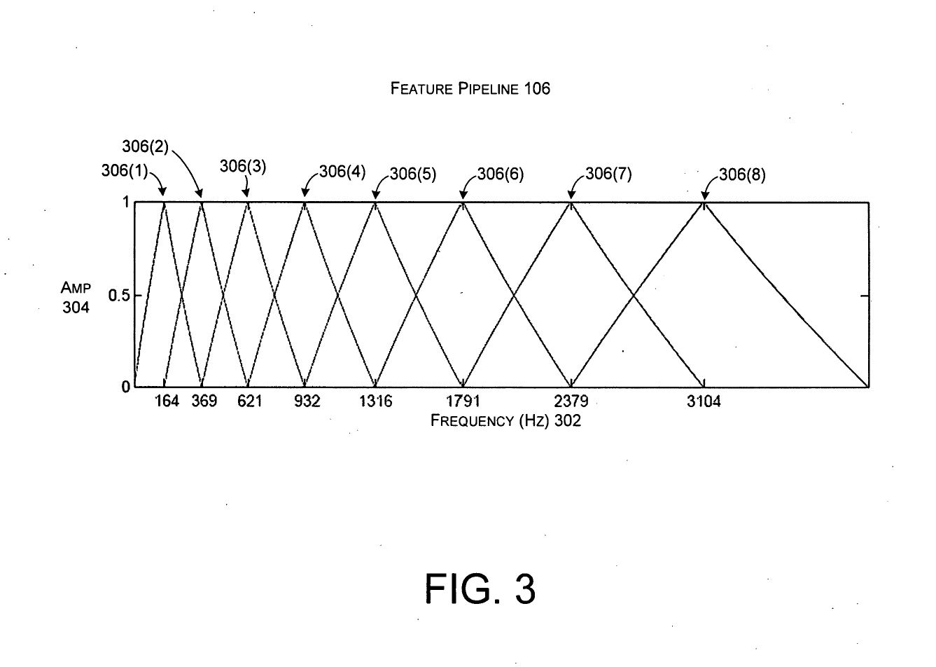

FIG. 3 offers an example of a graph 300 that illustrates Mel-scaled filter banks. Graph 300 is defined by frequency 302 (in hertz) on the horizontal axis and amplitude 304 on the vertical axis. For purposes of clarity graph 300 illustrates eight frequency peaks or bands 306(1)-306(8). Implementations described above and below may analyze 15-23 frequency peaks but only 8 frequency peaks 306(1)-306(8) are illustrated to avoid clutter on the graph 300.

Logarithms of the Mel coefficients can be then taken for the number of bands utilized in a given implementation. In the present implementation, applying 1-D or 2-D DCT or other de-correlating transforms on the 2-D Cepstra (TDC) generates an output that is a set of M=15−23 Log Mel coefficients per frame of audio. If the technique buffers the last F frames, e.g. F=15, then a rectangular matrix F×M is obtained where each row corresponds to one frames' Mel coefficients, and each column signifies the time trajectory of a single coefficient, showing how that coefficient evolved over the last F frames. This matrix is sometimes called the Two Dimensional Cepstra (TDC). The technique can pack all the information from this matrix into a few coefficients, either by performing a de-correlating transform such as Principal Component Analysis (PCA) or Discrete Cosine Transform (DCT) along the rows to de-correlate Mel coefficients from one another in a single frame, or along the columns, to de-correlate successive values of the same coefficient evolving over time, or along both rows and columns, using the principle of separability of the DCT:

$$F ( u , v ) = \sqrt{\frac{2}{M}} \sqrt{\frac{2}{F}} {\sum }_{i = 0}^{M - 1} {\sum }_{j = 0}^{F - 1} γ ( i ) γ ( j ) cos [ \frac{π u}{2 M} ( 2 i + 1 ) ] cos [ \frac{π v}{2 F} ( 2 j + 1 ) ] f ( i , j )$$

$$Where ;$$

$$γ ( x ) = \{ \begin{matrix}\frac{1}{\sqrt{2}} & for x = 0 \\ 1 & otherwise\end{matrix}$$

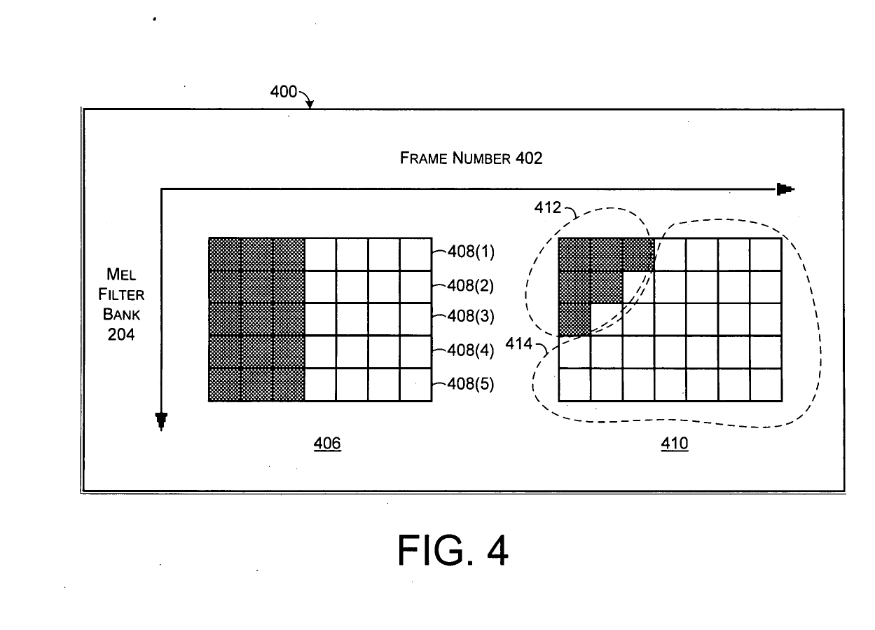

Some implementations can employ dimensionality reduction with 1-D and 2-D DCTs. For instance, the output produced above can be a 2-D matrix of 2-D DCT outputs, where the significant coefficients are around the (0, 0) coefficient, i.e. the low-pass, and the high pass coefficients carry very little energy and information. The information can be thought of as having been compacted/packed into the low pass band. Therefore, the technique can effectively reduce the dimensionality of the input feature vector for the classifier pipeline, and therefore, enable a light weight classifier architecture, by truncating many of the DCT output coefficients. Optionally, some implementations may ignore the zeroth DCT output coefficient—this is the DC or mean and sometimes does not carry much information, and ignoring it can potentially provide an inexpensive way to do power normalization. This dimensionality reduction step, besides enabling a light weight classifier, also results in a more accurate and robust classifier as is illustrated in FIG. 4.

FIG. 4 represents a graph 400 with a frame number 402 on the horizontal axis and a Mel filter bank 204 on the vertical axis. At portion 406, the graph shows dimensionality reduction after using 1-D DCTs along each individual Mel coefficient as it evolves with time. From a functional perspective, portion 406 illustrates that relatively long time trajectories 408(1)-408(5) can be utilized. The time trajectories can be transformed into a relatively low number of significant coefficients as possible for processing by the classifier pipeline. This configuration can benefit by looking at longer time trajectories, and yet reduces and/or minimizes the space/time footprint. Further, this configuration also enhances the robustness of the classification achieved by the classification pipeline.

At portion 410, the 2-D DCTs can jointly de-correlate along Mel banks and time, leading to more information compaction. Shaded boxes 412 are the compacted coefficients, the remaining boxes 414 are truncated.

The above mentioned technique provides a matrix of compacted and truncated coefficients to use as features. In the final step of the feature pipeline, the technique extracts the final feature vector that will be used by the classifier pipeline. There are two types of features that are extracted. The first is a subset of the result of DCT output, as explained above in relation to FIGS. 3-4.

The second type of features is the power feature(s). Recall that as mentioned above, the input speech can be normalized for more accurate comparison. However, the power feature conveys the power or power level of the input speech before normalization. To compute the power feature, the technique computes the mean, minimum and maximum power values over the trajectory of frames (e.g. for example trajectory length can equal 15). The min and max power values can be added to the feature vector after subtracting out the mean. The technique can also additionally add the power of the central frame of the trajectory after subtracting out the mean. Some implementations include the mean power value itself, and add the intensity offset value. The intensity offset is given as the average power of those frames where the power was above a silence threshold. The silence threshold is estimated at application setup time during a calibration process. The technique can also compute the delta power values throughout the trajectory, where deltas are straightforwardly computed as the difference between the power in frame i and frame i−1.

The combination of the dimensionality-reduced (via DCT) Mel coefficients and the power features can be used to compose the feature vector corresponding to each frame. This feature vector can then be input into the classification pipeline.

### Exemplary Classification Pipeline

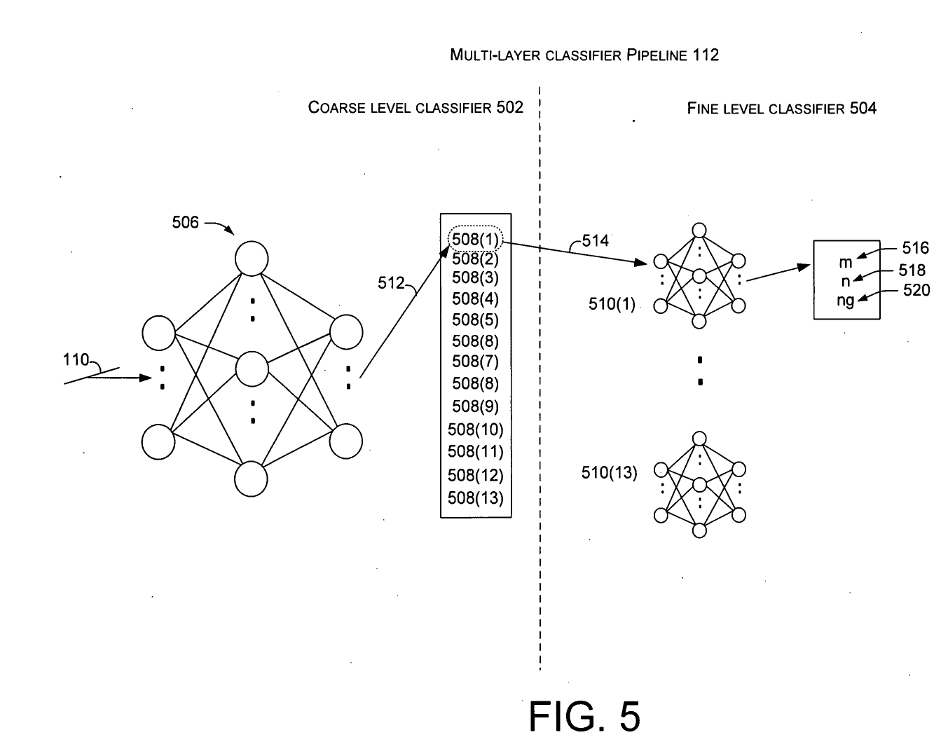

FIG. 5 shows a representation of a multi-layer classifier pipeline 112 that is consistent with some speech processing implementations. In this case, the speech feature vector 110 output by the feature pipeline 106 (FIG. 1) is fed as input to the classifier pipeline 112. The classifier pipeline 112 employs multiple classification levels. Here, the multiple classification levels can be thought of as an upper or coarse level classifier 502 and a lower or fine level classifier 504. Briefly, the coarse level classifier 502 can function to identify which phoneme class(es) matches the speech feature vector. An individual phoneme class may have multiple members or member phonemes. Once a phoneme class is selected by the coarse level classifier, the fine level classifier 504 can operate to distinguish or determine which member phoneme within the identified phoneme class matches the speech feature vector.

Authorities vary, but it is generally agreed that the English language utilizes a set of about 40 to about 60 phonemes. Some of the present implementations can utilize less than the total number of phonemes by folding together groups or sets of related and confusable phonemes in phoneme classes. For instance, nasal phonemes (e.g. “m”, “n”, “ng”), can be grouped as a single coarse-level phoneme class. Other examples of phonemes that can be grouped by class can include closures, stops, vowel groups, etc. By utilizing phoneme grouping, some implementations can utilize 5-20 phoneme classes in the coarse-level classifier and specific implementations can utilize 10-15 phoneme classes. The same principles can be applied to phonemes of other languages.

Coarse level classifier 502 can employ a neural network 506 to evaluate the input speech feature vector 110. In this instance, neural network 506 is configured as a multi-layer perceptron (MLP). The MLP can be thought of as a feed-forward neural network that maps sets of input data onto a set of output.

Assume for purposes of explanation that in relation to the example of FIG. 5 that the English language phonemes have been grouped into 13 phoneme classes 508(1)-508(13) and that individual phoneme classes include one or more member phonemes. Thus, the coarse level classifier 502 functions to identify which of the 13 phoneme classes 508(1)-508(13) the speech feature vector 110 matches. Individual phoneme classes 508(1)-508(13) can be further analyzed by individual Multi-Layer Perceptrons (MLPS) 510(1)-510(13) respectively, or other mechanisms of the fine level classifier 504. (Only fine level MLPs 510(1) and 510(13) are specifically illustrated due to the physical limitations of the drawing page upon which FIG. 5 appears).

Assume further, that in the present example, the coarse-level classifier 502 identifies a strong match between speech feature vector 110 and phoneme class 508(1) as indicated by arrow 512. For instance, assume that phoneme class 508(1) is the collective nasal phoneme class discussed above and that the coarse-level classifier determines that the speech feature vector matches class 508(1). At 514, this result can be sent to corresponding “fine level” MLP 510(1) corresponding to phoneme class 508(1) to further process the speech feature vector 110. The fine-level MLP 510(1) can function to determine whether the speech feature vector matches a particular phoneme of the collective nasal phoneme class 508(1). For instance, the fine-level classifier can attempt to determine whether the speech feature vector is an “m” phoneme as indicated at 516, “n” phoneme as indicated at 518 or “ng” phoneme as indicated at 520.

The function of the fine-level classifier can be simplified since it only has to attempt to distinguish between these three phonemes (“m”, “n”, and “ng”) (i.e., it doesn't need to know how to distinguish any other phonemes). Similarly, the function of the coarse-level classifier is simplified at least since it does not need to try to distinguish between similar sounding phonemes that are now grouped together. The configurations of the coarse and fine classifiers can promote higher accuracy phoneme matching results with potentially less resource usage.

In some configurations, additional fine level classifiers may also be run, and their outputs used in further processing. One design objective of performing coarse-to-fine classification can be to improve and/or maximize consistency of labeling speech—a potentially important ingredient of robust and accurate indexing/recall.

For example, the coarse level classifier 502 emits a likelihood or probabilities of the speech feature vector 110 belonging to a coarse level class (e.g. 13 top level classes 508(1)-508(13)). This may be followed by the fine level classifier 504 emitting the probability that the speech feature vector matches any given member phoneme belonging to its class. Since MLPs can be thought of as graphs, it can be convenient to view the whole architecture of multi-layer classifier pipeline 112 as a forest. The architecture is a “forest” in that the MLPs can work in tandem to make coarse level decisions and refine them at the fine level. Further, the MLPs can all work on the same set of input speech features.

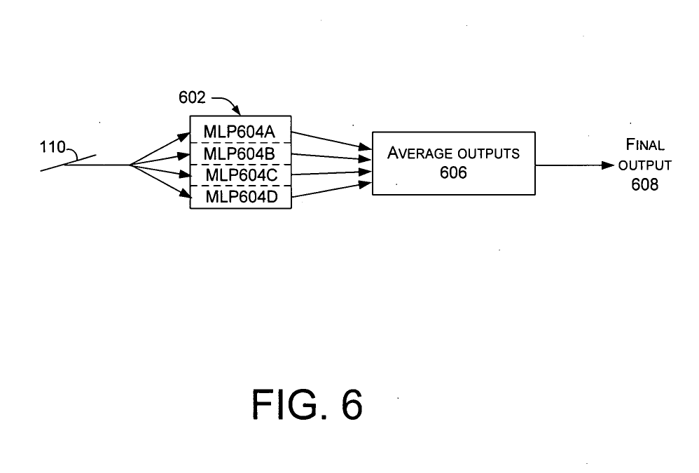

FIG. 6 shows an implementation that can use “committees” 602 of MLPs at individual process steps. In this case, committee 602 employs four MLPs (604A-604D), but the number is not critical and other implementations can utilize more or less MLPs in a committee. For sake of brevity only a single MLP committee 602 is illustrated, but multiple committees could be employed to analyze speech data.

This implementation combines the committee's results (output probabilities) by averaging at 606 to produce the final output 608. This technique can combat any data skew problem that might otherwise occur in the coarse level output. One potential data skew problem is that speech training data is typically imbalanced in that some phonemes, like vowels, have lots of training examples, whereas training examples for other phonemes, like stops and closures, are extremely sparse. This usually leads to MLP classifiers overtraining on the dense phonemes, and under-representing the sparse phonemes. By using MLP committees, some implementations are able to partition the training data so as to artificially balance the dense phonemes across the committee members, so that each committee member becomes responsible for representing a partition of the classes. Stated another way, by default, training tends to emphasize high density classes. To counteract this occurrence some committee members can be configured to emphasize the remaining classes. The output of the various committee members can be averaged or otherwise combined to produce the overall classification of the committee. In summary, a committee having members of varying emphasis can produce more accurate results than utilizing a uniform training scenario.

The above description relates to the top level organization of the MLP families (i.e. forest) and committees of some implementations. The following description provides a greater level of detail into the sequence of operations inside of individual MLPs of some implementations of the multi-layer classification pipeline 112.

The complete set of operations starting from the post-DCT step vector, X, leading to the phoneme probability vector, Y, is summarized in the equation below:

$${y}_{i} = ψ ( {\sum }_{k = 1}^{m} {w}_{ki} φ ( {\sum }_{j = 1}^{d} {w}_{jk} μ ( {x}_{j} ) - θ ) - η ) , … \{ {w}_{jk} , {w}_{k} , {θ}_{k} , η ∈ , μ ( \cdot ) , φ ( \cdot ) , ψ ( \cdot ) : -> .$$

In one example, a fully connected, feed-forward multi-layer perceptron (MLP) has d (e.g. d=160) input units, m hidden units (e.g. m=40) and n output units (e.g. n=13). The above equation describes how the ith output unit (i.e. of the n output units) gets computed.

1) First the normalization function, μ is applied on the input vector, X. μ is defined as the scalar term-by-term product of a vector sum (i.e. bias followed by scale), as follows:

μ=S•(X+B)

2) Next, wⱼₖ denotes the weight value that connects the j^{th} unit in the input layer to the k^{th} unit in the hidden layer, for j=1, 2, . . . , d; for k=1, 2, . . . , m.

3) θ is the threshold value subtracted at the hidden layer.

To enable 2) and 3) to happen as one matrix multiplication step, the technique can append a “−1” to the vector resulting from the step. Thus, the matrix multiplication step leading to hidden node activations looks like the following (e.g. μ is 1×161, and WIH is 161×41, and H is 1×41):

H̅= μ̅× W̅_{IH}

4) Φ(.) is the logistic activation function applied at the hidden layer and is given by the following equation:

$$φ ( z ) = \frac{1}{1 + {e}^{- z}}$$

5) wki denotes the weight value that connects the kth unit in the hidden layer to the ith unit in the output layer, for k=1, 2, . . . , m; i=1, 2, . . . , n.

6) η is the threshold value subtracted at the output layer.

The matrix multiplication looks like the following (e.g. Φ is 1×41, W_{HO} is 41×13, and O is 1×13):

Ō= φ̅× W̅_{HO}

7) ψ(.) is the soft max activation function applied at the output layer, and is given by the following equation:

$$ψ ( z ) = \frac{{e}^{z}}{{\sum }_{i = 1}^{n} {e}^{z}}$$

8) Once the technique computes the output vector, Y, this implementation lastly can take a natural logarithm of each element of this vector, i.e. Lg (Y) to compute the vector of phoneme-wise log probabilities. A sub-set of these can be sent to the final stage of decoding.

MLP Quantization into Nibbles and Bytes

As introduced above, some of the present speech processing implementations can be directed toward resource constrained applications. Some of these configurations can quantize weights of the MLP classifiers in order to operate within these resource constrained applications and/or to be implemented in fixed point arithmetic. Weights of the MLP are the multiplicative factors applied along each arc of activation. For example, if there is a connection between an input node I and a hidden node H, then there will also be a weight, W_HI, which is a floating point number, which means that the input value at I will be multiplied by W_HI before contributing to the hidden activation at H. In a fully connected topology the hidden activations are simply the sum of all such weighted inputs (i.e., Activation(H(i))=Sigmoid(Sum over all I, j of Inputs I*Weight(I, j)). One such example is evidenced above in the equations between paragraphs 00047 and 00048 where the W_IH are the weights.

In some instances, a classifier pipeline that fits in less memory than existing technologies can be directed toward this (or these) design parameters. For instance, the present implementations can enable classifier pipeline configurations that occupy under 100 kilobytes (and in some cases under 60 kilobytes) of memory. From one perspective at least some of the present implementations can compactly code the parameters of the MLP (i.e. the weight values) as nibbles and bytes in order to decrease storage requirements of the MLP.

Some configurations can achieve this level of compression by shaping the parameter distributions into Laplacians—these have a spike at zero, and long skinny tails to both sides.

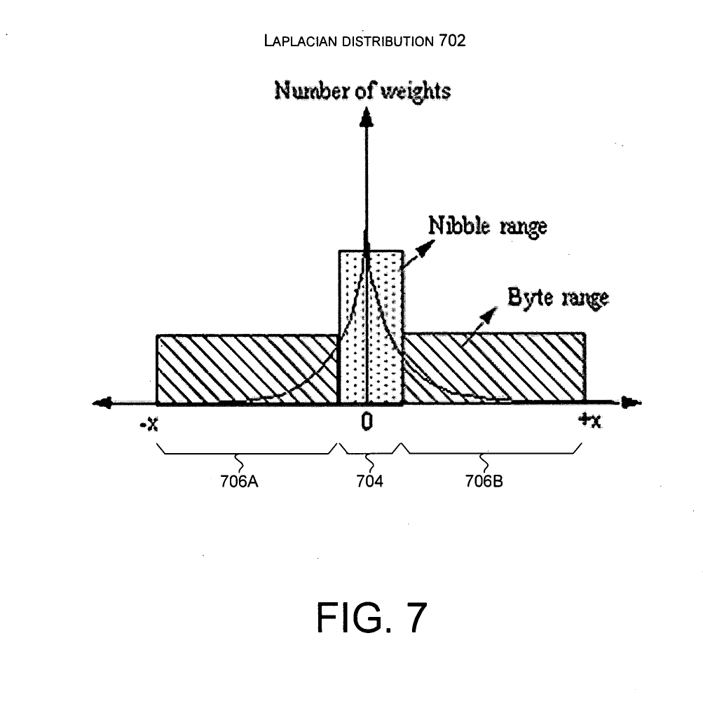

FIG. 7 offers an example of Laplacian distribution generally at 702. Some implementations can use a lookup table, such as of size 16 to represent the central range 704 which accounts for ˜95% of the MLP parameters—these effectively get encoded as nibbles or half-bytes. The remaining coefficients that are in the tails 706A and 706B of the Laplacians are quantized into bytes.

In this example, MLP weights can be shaped to follow Laplacian distributions. A small area around zero (e.g. [−0.035, 0.035]) is quantized into nibbles via a table lookup, and the rest are quantized as bytes.

The technique can then pack the quantized MLP parameters as follows: the nibble lookup table contains a “hole” at 1000, which corresponds to “−0”, which does not exist. Therefore, the technique uses this value as an “escape sequence”, to signal that this coefficient is quantized as a byte, i.e. read the next 2 nibbles for this parameter value.

One implementation utilizes the following nibble lookup table:

NibbleLUT={0.0f, 0.06f, 0.12f, 0.18f, 0.24f, 0.30f, 0.36f, 0.42f}
const float c_maxShortCodeWord = 0.45f.

Each weight can be quantized either as a short (i.e. nibble) or a long (i.e. byte) code word, as follows in one exemplary configuration:

```
void QuantizeWeight(float weight)
{
  bool sgn = (weight <= −c_minShortCodeWord);
  float absWeight = Math.Abs(weight);
      bool escaped = false;
  quantizedWeight = 0;
  if (absWeight < c_maxShortCodeWord)
  {
    ShortCodeWord(absWeight, ref quantizedWeight);
  }
  else
  {
    escaped = true;
    LongCodeWord(absWeight, ref quantizedWeight);
  }
  if (sgn)
  {
    if (escaped)
    {
      quantizedWeight |= 0x80; // sign big
    }
    else
    {
      quantizedWeight += 7; // LUT is of size 15 and has // no holes in
      it!
    }
  }
}
void LongCodeWord(float absWeight, ref short quantizedWeight)
{
  quantizedWeight = 0;
  quantizedWeight = (short)(absWeight/quantizationInterval);
}
void ShortCodeWord(float absWeight, ref short quantizedWeight)
{
  if (absWeight < c_minShortCodeWord)
  {
    quantizedWeight = 0;
  }
  else if (absWeight < 0.09f)
  {
    quantizedWeight = 1;
  }
  else if (absWeight < 0.15f)
  {
    quantizedWeight = 2;
  }
  else if (absWeight < 0.21f)
  {
    quantizedWeight = 3;
  }
  else if (absWeight < 0.27f)
  {
    quantizedWeight = 4;
  }
  else if (absWeight < 0.33f)
  {
    quantizedWeight = 5;
  }
  else if (absWeight < 0.39f)
  {
    quantizedWeight = 6;
  }
  else if (absWeight < c_maxShortCodeWord)
  {
    quantizedWeight = 7;
  }
}
```

### Decoder

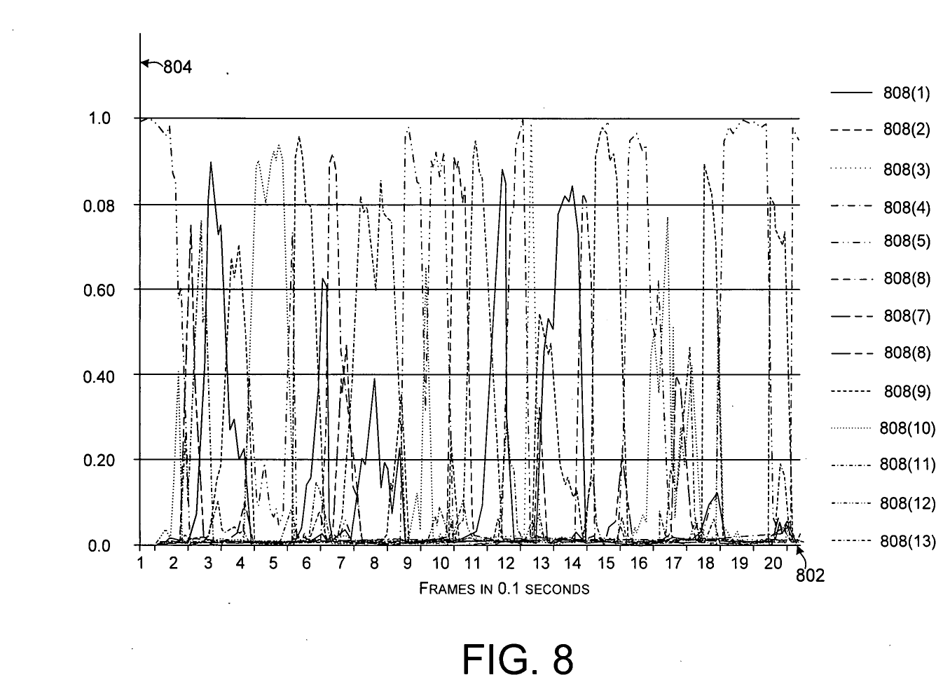

The decoder can function to discretize the classifier output. The classifier output can be relatively continuous and the decoder can transform the classifier output into a discrete sequence of symbols. In some implementations, the decoder accomplishes this functionality by looking at a time trajectory of class probabilities and using a set of heuristics to output a sequence of discrete symbols. An example of one of these implementations is described in more detail below in relation to FIGS. 8-11 collectively.

Input to the decoder: The input to the decoder can be a time series of real valued probability distributions. FIG. 8 shows an example of how this implementation can generate a graph 800 from the decoder input. Graph 800 shows a plot of the trajectory of each phoneme class with respect to time t on horizontal axis 802 as frames in 0.1 seconds and probability from 0.0 to 1.0 on the vertical axis 804. Suppose that the high or coarse-level classifier tries classifying the speech into k different phoneme classes. In this example k=13 so the phoneme classes are designated as 808(1)-808(13) with each phoneme class being indicated with a different type of line on the FIGURE. At each time t, the decoder emits a vector of k non-negative real values which sum to one.

In this case, from an overview perspective, the decoder can perform three major tasks. First, the decoder can search for high-level class segments. Second, for each high-level class segment the decoder can try to determine a fine level class. Third, the decoder can filter the segmentation in a post-processing step to remove symbols or speech descriptors spuriously generated during a period of non-vocalization.

### High-Level Class Determination:

In this case, there is a three step process for segmenting the classifier trajectories into high-level classes. First, a high-level (coarse) segmentation into “sure-things” is found and those regions are expanded. Next, the technique tries to find periods where the classifier knows the audio belongs to one of two classes. Finally, the decoder fills in any remaining gaps of some minimal length with a “wildcard” symbol or speech descriptors.

The first heuristic that the decoder uses is one that determines “sure things.” A threshold T′ is chosen such that whenever a phoneme class probability is higher than T′, that segment of time will be classified according to that phoneme class. If T′>=0.5, then there is an implied mutual exclusion principle in play in that at most one phoneme class can have a probability of occurring that is greater than 0.5. This is where the name “sure-thing” comes from in that only one high-level class can be in such a privileged position.

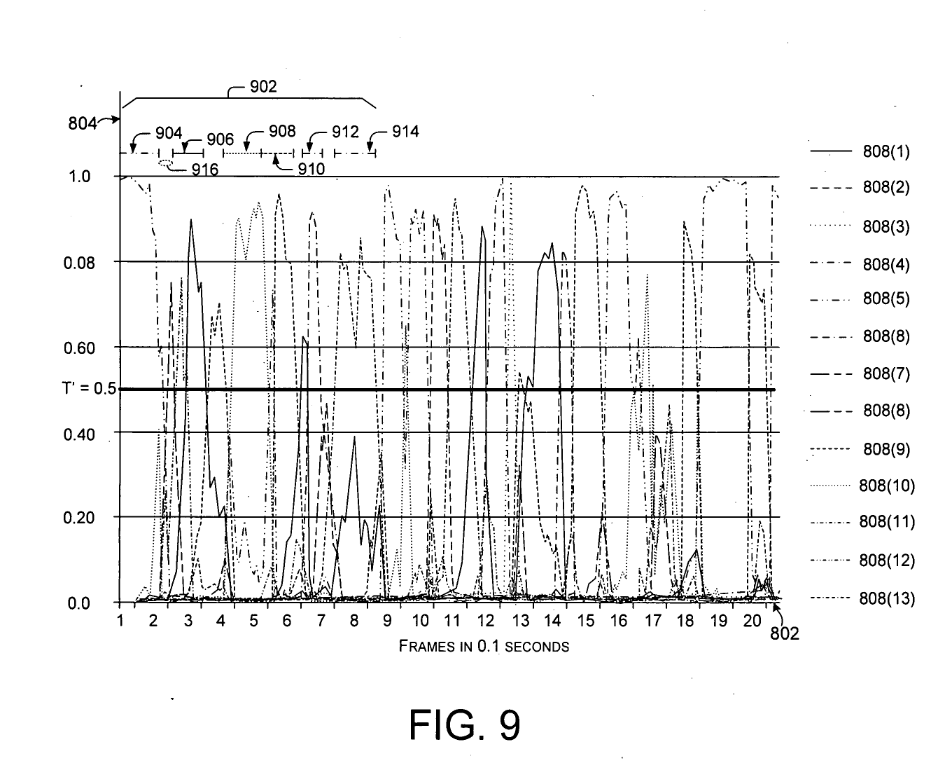

FIG. 9 builds upon graph 800 with the inclusion of threshold T′ (introduced above) to which the probabilities can be compared. In this case, threshold T′ is set to 0.5. In FIG. 9, graph 800 also shows generally at 902 how the first few time segments are decoded according to the sure-thing criteria. For instance, a first period 904 of the graph is matched with class 808(5) (i.e., a probability of class 808(5) is above threshold T′ for period 904. Similarly, a second period 906 is matched to class 808(1), a third period 908 is matched to class 808(10), a fourth period 910 is matched to class 808(9), a fifth period 912 is matched to class 808(4),a sixth period 914 is matched to class 808(12).

In this implementation, matching can be performed only for periods where a single class is matched for a minimum duration of time. For instance, period 916 defined between periods 904 and 906 is not matched to a phoneme class even though it appears that the value of class 808(2) exceeds threshold T′ because the period does not meet the predefined minimum duration. An alternative implementation can identify all periods where a single phoneme class exceeds threshold T′. The duration of the identified periods can then be considered as a factor for further processing. For instance, matched periods that do not satisfy the minimum duration may not be recorded while those that meet the minimum duration are recorded.

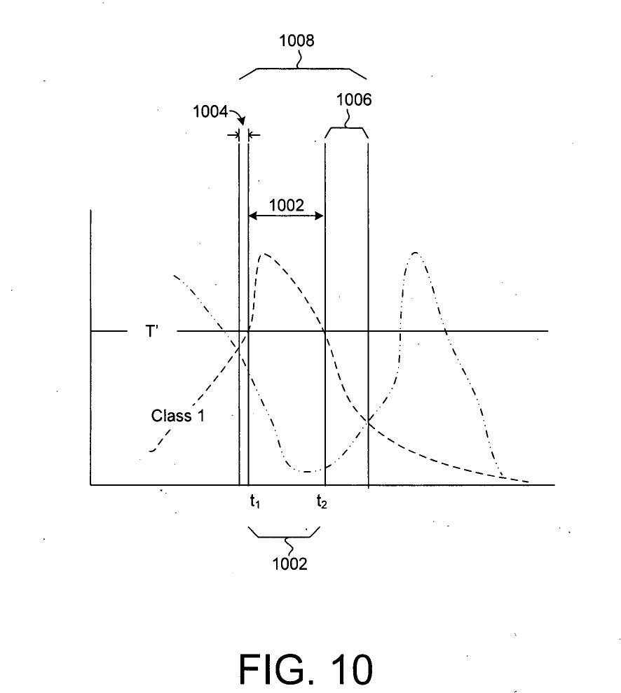

FIG. 10 illustrates how temporal borders of the sure-thing zones can be determined. Once all of the sure-thing segments have been identified, they can be extended in the following manner. Suppose that class 1 is a sure-thing from time t₁ to t₂ as indicated at 1002. Before t₁, the probability of class 1 was less than threshold T′, and similarly after time t₂. Because the probability of class 1 wasn't above T′ outside of the interval (t₁, t₂) does not imply that it should not be the chosen phoneme class. This technique can start at time t₁−1 and scan backwards, extending the extent of the segment until the probability of class 1 no longer beats the probability of other classes. This process thus extends class 1 for a duration indicated at 1004. Similarly, the technique can look forward after time t₂ for the same condition as indicated by duration 1006. Accordingly, an extended duration or segment 1008 can be formulated for class 1 from the sure thing segment 1002 plus additional segments 1004 and 1006.

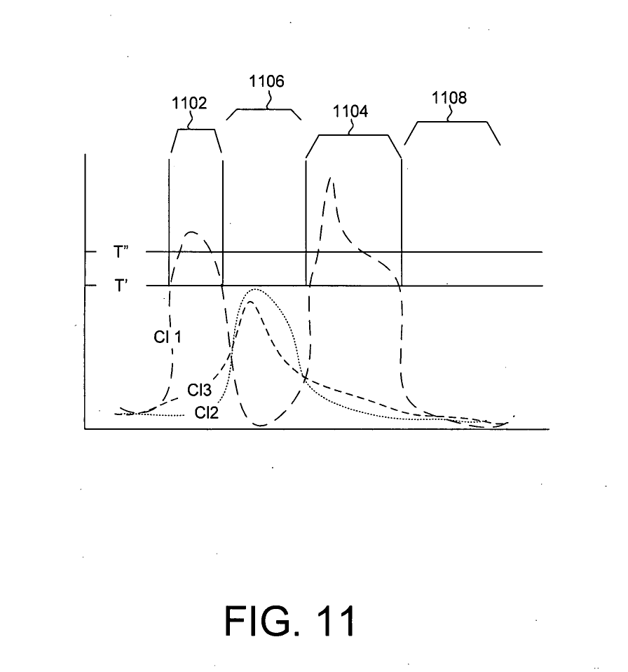

After looking for sure-thing segments and extending them, the technique moves on to the next phase of decoding in which the technique identifies segments where one of two sound classes is very likely. This can happen when the classifier is confused between two classes, but it is relatively sure that it is one of those two classes. The technique can accomplish this as follows. First, the technique looks at all time intervals for which there isn't an extended sure-thing segment. If the sum of the two most likely classes is above some higher threshold T” (for example, T″=0.65-0.75) from time (t₁, t₂) then the technique creates a segment for which there is a class winner and a class runner-up. An example of such a process is evidenced in FIG. 11.

In the illustrated scenario of FIG. 11, a sure thing is identified for phoneme class 1 at 1102 and again at 1104. During the intervening period 1106 phoneme class 2 is identified as a “winner” and phoneme class 3 is identified as a “runner-up” since the sum of the combined probabilities of these two phoneme classes exceeds threshold T″ even though neither of them exceeds threshold T′ on their own.

The final step of the high-level decoder is to assign segments of time for which the classifier is confused with a “wildcard” symbol. This symbol is mainly used for duration alignment. In essence, time segments that remain unclassified time after the above processes identify sure-things, winners and runners-up which have some minimum predefined duration D are classified with wildcard symbols. In the example trajectory of FIG. 11, the period of time designated at 1108 would be classified as a wildcard segment with a wildcard symbol.

### Fine-Level Class Determination:

After high-level decoding the classifier trajectory has been segmented into intervals. Most of these intervals have been classified according to the sure-thing criterion previously described. For those particular segments the technique attempts to find a fine-level classification. Each coarse-level class has an associated fine-level classifier which has learned to distinguish between different sounds within a class. If class 1 is the winner during time segment (t₁, t₂), then the technique examines the output of the class 1 fine-level classifier over the interval (t₁, t₂). The exemplary heuristic here is to examine the average probability of each fine-level class over the interval (t₁, t₂). If one of these fine-level classes has an average probability above some threshold T_fine, then the technique assigns that class to be the fine-level symbol for the segment.

### Removing Silence Regions:

Some implementations can remove symbols or speech descriptors generated during regions of silence because the symbols tend to be spurious and do not correspond to the user's vocalized remembrance or query. Some of the described algorithms are performed as a post-processing step which can be based off of knowledge of log-energy trajectory during the utterance. An explanation of an example of these algorithms is described below.

The technique can scan the log-energy trajectory after the vocalization has occurred. The technique can find the minimum frame log-energy value MIN and the maximum frame log-energy value MAX. The technique can compute a threshold T=MIN+alpha (MAX-MIN), for some alpha in the range (0, 1). The technique can find all time intervals (t₁, t₂) such that the log-energy is above threshold T during the time interval. Each interval (t₁, t₂) is considered a “strong vocalization region.” Because some words have soft entrances (such as “finished”) and others have drawn out soft sounds at the ending, the technique can extend each strong vocalization region by a certain number of milliseconds in each direction. Thus, after the extension, the interval (t₁, t₂) will become (t₁−Δ, t₂+Δ,). In other words, the technique can effectively stretch out each interval in both directions. Basically once evidence identifies something, the technique can stretch the identified interval so as not to miss something subtle on either side. For instance, consider the enunciation of the word “finished”. This word starts really soft (i.e., the “f” sound) so the first part of the word is hard to identify. Once the stronger part(s) of the word (i.e., the first “i”) is identified the technique may then more readily identify the softer beginning part of the word as part of the word rather than background noise.

These extended vocalization regions are used to filter the sequence of sounds that are indexed. Any decoded symbol that occurs beyond the extent of a vocalization region is not indexed.

### Output Representation

Output representation can be thought of as what gets indexed in a database responsive to the above described processes. It is worth noting that some of the present implementations perform satisfactorily without performing speech recognition in the traditional sense. Instead, these implementations can perform noise robust speech pattern matching on symbols derived from phonemes. From one perspective these implementations can offer a reliable and consistent 1-way hash function from speech into a symbol stream, such that when the same user says the same thing, pronounced in roughly the same way (as most speakers tend to do). The corresponding sequence of symbols emitted by the end-to-end processing pipeline will be nearly the same. That is the premise on which these implementations can perform speech based indexing and recall. Some implementations can build upon the above mentioned techniques to provide speech recognition while potentially utilizing reduced resources compared to existing solutions.

Alternatively or additionally, the present implementations can reduce and/or eliminate instances of out of vocabulary (OOV) terms. Traditional speech recognition systems are tied to a language model (LM). Any words that are not present in the LM will cause the speech recognition system to break down in the vicinity of OOV words or terms. This problem can be avoided to a large degree because the present implementations can pattern match on speech descriptors or symbols derived from phonemes. For many target usage scenarios, OOV is expected to account for a large percentage of words (e.g. grocery list: milk, pita, eggs, Camembert), and so this is potentially important to the speech pattern recognition context. Additionally, this feature can allow the present techniques to be language neutral to a degree.

Some implementations that are directed to a low space/time footprint and are intended to be free from the pitfalls of LM models can be indexed on n-grams of symbols derived from phonemes. This approach can pre-cluster the phonemes based on acoustic confusability and then index lattices of cluster indexes rather than on phoneme indexes. This can reduce entropy and symbol alphabet size, as well as improve the robustness of the system.

Another potentially valuable simplification of some of the present techniques when compared to traditional speech recognition is that the present techniques don't need to continually emit words to the user as would be performed by existing transcription type applications. Instead, these techniques can output just enough symbols to reliably index and recall the speech that they enter into the device and query on later. Therefore, when the classifier pipeline is confused, i.e. there is no clear “winner” or “sure-thing” phoneme class descriptor, it can simply emit a wildcard symbol. There appears to be good correlation between users saying something and where wildcards occur when the classifier runs on the speech, and so this is also something that helps in indexing and recall, besides further reducing symbol level entropy.

An example of a symbol stream that includes a set of phoneme class symbols (emitted by the coarse level classifier MLPs), fine level phoneme symbols and wildcard class symbols that are actually emitted by a speech pipeline in one implementation is listed below.

### Coarse Level:

| PHONEME CLASS | MEMBER PHONEME |
|---|---|
| 0 | “a” vowels |
| 1 | Semi-vowels |
| 2 | closures |
| 3 | affricatives |
| 4 | nasals |
| 5 | Stop and one nasal |
| 6 | Semi-vowels and one stop |
| 7 | “I” vowels |
| 8 | fricatives |
| 9 | Pause/silence |
| 10 | Stop sub-class |
| 11 | stops |
| 12 | “o” vowels |
| Wildcard | |

### Fine Level:

| PHONEME CLASS | MEMBER PHONEME |
|---|---|
| “a” vowels | “aa”, “ao”, “ae”, “ah”, “aw”, “ay”, “eh”, |
| | “i”, “ax”, “ae”, “el”, “I”, or “ow” |
| Semi-vowels | “er”, “r”, “axr” |
| closures | “bcl”, “dcl”, “gcl”, “kcl”, “pcl”, or “tcl” |
| affricatives | “ch”, “jh”, “sh”, or “zh” |
| nasals | “dh”, “m”, “n”, “ng”, “em”, “en”, “eng”, or “v” |
| Stop and one nasal | “dx” or “nx” |
| Semi-vowels and one | “epi”, “hh”, “hv”, or “q” |
| stop | |
| “I” vowels | “ey”, “ih”, “ix”, “iy”, “ux”, “y”, or “uw” |
| fricatives | “f”, “th”, “s”, or “z” |
| Pause/silence | “h” or “pau” |
| Stop sub-class | “k”, “t”, or “p” |
| stops | “b”, “d”, or “g” |
| “o” vowels | “oy”, “uh”, or “w” |
| Wildcard | |

The above listed example effectively constitutes the symbol stream that can be indexed and recalled in accordance with some implementations. This example is not intended to be limiting or all-inclusive. For instance, other implementations can utilize other coarse level and/or fine level organizations. Further, additional or alternative phonemes from those listed above within a class may be distinguished from one another by the respective fine level classifier. (Examples of indexing algorithms that can be utilized with the present techniques can be found in U.S. patent application Ser. No. 11/923,430, filed on Oct. 24, 2007).

### Operating Environments

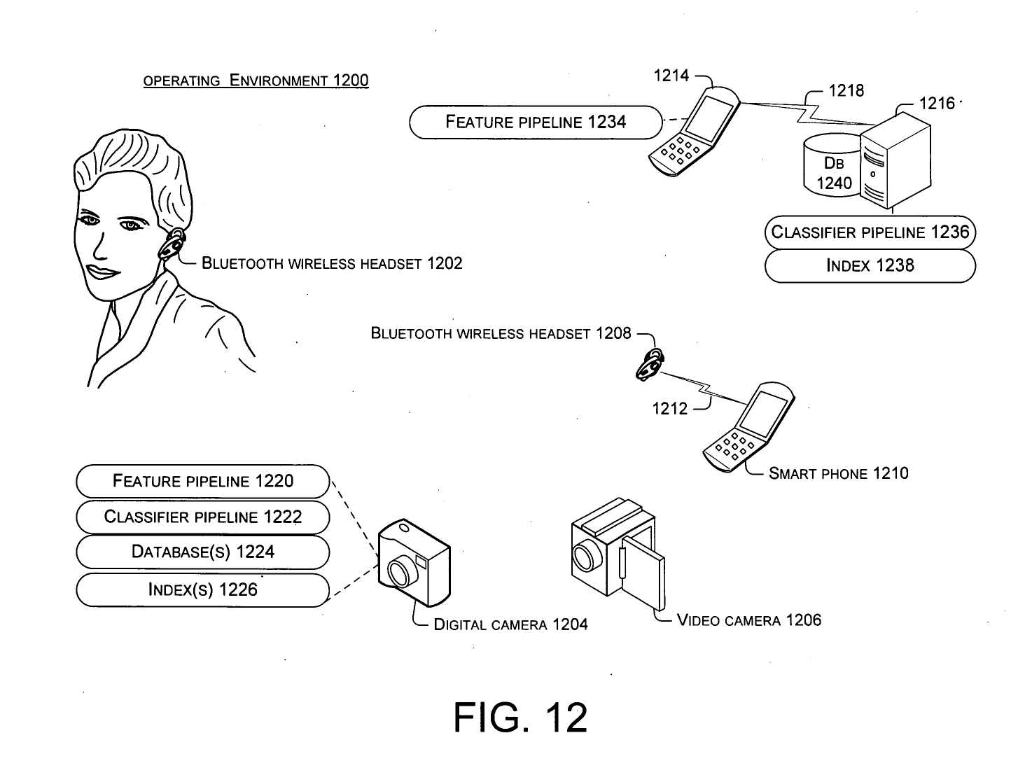

FIG. 12 shows several exemplary operating environments 1200 in which the speech interface concepts described above and below can be implemented on various digital devices that have some level of processing capability. Some configurations include a single stand-alone digital device, while other implementations can be accomplished in a distributed setting that includes multiple digital devices that are communicatively coupled. In this case, three stand-alone configurations are illustrated as a Bluetooth wireless headset 1202, a digital camera 1204, and a video camera 1206. The distributed settings include a Bluetooth wireless headset 1208 communicatively coupled with a smart/cell phone 1210 at 1212 and a smart/cell phone 1214 communicatively coupled with a server computer 1216 at 1218.

In the standalone configurations, the digital device can employ various components to provide a speech interface functionality. For instance, digital camera 1204 is shown with a feature pipeline component 1220, a classifier pipeline component 1222, a database 1224, and an index(s) 1226.

In a distributed setting, any combination of components can operate on the included digital devices. By way of example, feature pipeline 1234 is implemented on smart phone 1214 while the classifier pipeline 1236, index 1238 and database 1240 are associated with server computer 12.16. Such a configuration can be implemented with relatively low processing resources on the smart phone 1214 and yet the amount of information communicated from the smart phone to the server computer 1216 can be significantly reduced. The server computer can employ relatively large amounts of processing resources to the received data and can store large amounts of data in database 1240.

Both the stand-alone and distributed configurations can allow a user to speak into the digital device to store and retrieve his/her thoughts in that the device(s) can perform automatic speech grouping, search and retrieval. The speech can be processed into a reproducible representation that can then be searched. For instance, the speech can be converted to symbols in a repeatable manner such that the user can subsequently search for specific portions of the speech by repeating words or phrases of the original speech with a query command such as “find”. The symbols generated from the query can be compared to the symbols generated from the original speech and when a match is identified the digital device(s) can retrieve some duration of speech, such as one minute of speech that contains the query. The retrieved speech can then be played back for the user. Some implementations can allow additional functionality. For instance, some implementations can store speech as described above, but may also perform speech recognition to the input speech such that the speech can be displayed for the user and/or the user can subsequently enter a written query on a user-interface of a digital device that can then be searched for the stored speech. Such a configuration can enable various techniques where the user subsequently queries the stored speech from a digital device that does not have a microphone.

Viewed another way, the exemplary digital devices 1202, 1204, 1206, 1208, 1210, 1214 and 1216 can be thought of as cognitive aids. For instance, Bluetooth wireless headset 1202 can be conveniently and unobtrusively worn by a user as a touch free Dictaphone. When the user has ideas or thoughts that he/she wants to retain he/she can simply speak the ideas into the headset. Later, the user can retrieve the details with a simple query.

Some implementations can allow the user to associate speech with other data. For instance, the digital camera 1204 can allow the user to take a digital picture and then speak into the camera. The speech can be processed as described above, and can also be associated with, or tagged to the picture via a datatable or other mechanism. The user can then query the stored speech to retrieve the tagged data.

For example, the user may speak into the digital device. The digital device can store some derivative of the speech in a searchable form. For instance, the user may say “I saw Mt. Rainier on my trip to Seattle”. The user can subsequently command “find Seattle” or “find Rainier” to retrieve the relevant stored speech which can then be repeated back to the user. In still another case, the speech interface may allow the user to associate a spoken tag with a document, video or other data. For instance, the user may tag a photo in digital camera 1204 by saying “picture of Mt. Rainier”. The user can subsequently say “find Rainier” to retrieve the picture which is cross-referenced with the speech in the datatable.

The present concepts can lend themselves to offering speech pattern recognition on devices that generally cannot handle traditional speech recognition applications. For instance, traditional speech recognition applications tend to have relatively high memory requirements to facilitate state space searching. For example, wireless headsets, smart/cell phones, cameras and video cameras traditionally do not have sufficient resources to handle traditional speech recognition applications. In contrast, at least some of the present implementations can leverage processor resources to function with reduced memory requirements. For instance, the processor can accomplish speech pattern recognition via a sequence of digital signal processing (DSP) steps that can include multi-layer perceptron (MLP) configurations. Thus, the speech pattern recognition processing can be viewed as a vector×matrix operation. In some implementations relatively high classification accuracy can be attained by processing a long temporal sequence of frames (such as 0.1-0.2 seconds). Dimensionality reduction of the speech data and selecting which speech data features to classify are but two factors that can allow some implementations to operate with relatively low processing/memory availability levels.

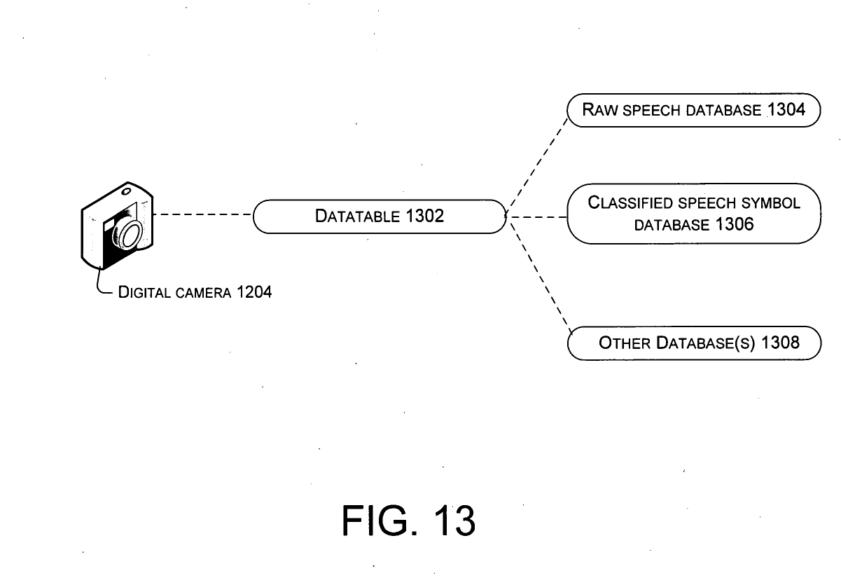

FIG. 13 offers an example of how the datatable mentioned above can be implemented. In this case, digital camera 1204 includes a datatable 1302 that can track the name and/or location of corresponding data. For ease of explanation, separate data types are stored in separate databases, but such need not be the case. In this implementation, input speech is stored in a raw speech database 1304 (in a compressed or uncompressed form), processed speech is stored in a classified speech symbol database 1306 and other data such as the camera's digital images are stored in “other” database 1308. The datatable 1302 can maintain the correlation between the data in the various databases. For instance, the datatable can cross-reference associated data. In one example, the datatable can cross-reference that the original raw speech “I saw Mt. Rainier on my trip to Seattle” is stored at a specific location in raw speech database 1304, that the corresponding classified speech symbols are stored at a specific location in classified speech symbol database 1306 and that the speech is associated with, or tagged to, a specific image stored in other database 1308. The skilled artisan should recognize other mechanisms for achieving this functionality. Accordingly, a future query can retrieve one or all of the associated data.

Beyond the specific examples offered in FIGS. 12-13 these concepts can be applied to any setting where speech based indexing and recall (i.e., smart notes) may offer an enhanced digital functionality. For instance, these concepts can be applied in multimedia search (e.g. MSN audio and video search), multimedia databases, query and retrieval of video and audio clips, context mining, automatic theme identification and grouping, mind mapping, language identification, and robotics, etc.

Exemplary digital devices can include some type of processing mechanism and thus the digital devices can be thought of as computing devices that can process instructions stored on computer readable media. The instructions can be stored on any suitable hardware, software, firmware, or combination thereof. In one case, the inventive techniques described herein can be stored on a computer-readable storage media as a set of instructions such that execution by a computing device causes the computing device to perform the technique.

### CONCLUSION

Although techniques, methods, devices, systems, etc., pertaining to speech interface scenarios and speech pattern recognition scenarios are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a feature pipeline configured to produce speech feature vectors from speech; and,
a classifier pipeline configured to classify individual speech feature vectors utilizing multi-level classification.

2. The system of claim 1, wherein the feature pipeline is configured to record a power level of the speech at multiple frequencies and to normalize the speech to a reference level for further processing.

3. The system of claim 2, wherein the feature pipeline is configured to produce the speech feature vectors from the speech utilizing a combination of dimensionality-reduced Mel coefficients and the power level.

4. The system of claim 1, wherein the classifier pipeline comprises a first coarse-level classifier configured to identify a probability that an individual speech feature vector matches one or more phoneme classes, wherein individual phoneme classes include one or more member phonemes.

5. The system of claim 4, wherein the classifier pipeline further comprises a second fine-level classifier configured to identify a probability that the individual speech feature vector matches individual member phonemes of an identified phoneme class.

6. The system of claim 1, wherein the classifier pipeline comprises a first multi-layer perceptron (MLP) configured to provide coarse level classification on the speech feature vectors and a second MLP configured to receive output from the first MLP and provide fine level classification.

7. The system of claim 1, wherein at least a portion of the classifier pipeline is stored in memory as nibbles and bytes.

8. The system of claim 1, wherein the classifier pipeline comprises a committee of multi-layer perceptrons (MLPs) configured to provide coarse level classification on the speech feature vectors and wherein some MLPs of the committee are trained to emphasize identifying some phoneme classes while other different MLPs of the committee are trained to emphasize identifying other different phoneme classes.

9. A computer-readable storage media having instructions stored thereon that when executed by a computing device cause the computing device to perform acts, comprising:
receiving speech;
identifying a probability that a segment of the speech matches one or more phoneme classes, where phoneme classes include one or more phonemes; and,
determining a probability that the segment matches an individual phoneme of an identified phoneme class.

10. The computer-readable storage media of claim 9, wherein the receiving comprises processing the speech to generate corresponding de-correlated data and wherein the identifying comprises identifying a probability that the de-correlated data matches one or two of the one or more phoneme classes.

11. The computer-readable storage media of claim 9, wherein the identifying further comprises comparing the probability for individual phoneme classes to a threshold and in an instance where the probability for an individual phoneme class exceeds the threshold then recording a symbol that indicates that the segment matches the individual phoneme class.

12. The computer-readable storage media of claim 9, wherein the identifying further comprises comparing the probability for individual phoneme classes to a first threshold and in an instance where the probability for any individual phoneme class is less than the first threshold, but where combined probabilities of two individual phoneme classes exceeds a second threshold then recording that the segment matches either of the two individual phoneme classes.

13. The computer-readable storage media of claim 9, wherein the identifying further comprises comparing the probability for individual phoneme classes to a first threshold and in an instance where the probability for any individual phoneme class is less than the first threshold and a combined probabilities of any two individual phoneme classes does not exceed a second threshold then recording a wildcard symbol for the segment that indicates that the segment is unknown.

14. The computer-readable storage media of claim 9, wherein the determining indicates a match where the probability for an individual phoneme exceeds a threshold.

15. The computer-readable storage media of claim 9, further comprising in an instance where a duration of the segment exceeds a minimum value, recording a symbol that corresponds to the identified phoneme class and another symbol that corresponds to the determined phoneme.

16. A method, comprising:
receiving probabilities that speech corresponds to one or more phoneme classes; and,
based at least in part on the probabilities, assigning a segment of the speech one of: a single phoneme-based speech descriptor symbol, two alternative phoneme-based speech descriptor symbols, and a wildcard symbol.

17. The method of claim 16, wherein the assigning is based upon a graphical representation of probabilities of the speech matching individual phoneme classes over time.

18. The method of claim 16, wherein the assigning is performed where a duration of the segment is at least about 100 milliseconds.

19. The method of claim 16, further comprising recording the assigned symbol or symbols and a duration of the segment.

20. The method of claim 16, further comprising in an instance where a duration of the segment is below a predefined value then not recording the assigned symbol.
